(19) United States
(12) Patent Application Publication
(10) Pub. No.: US 2023/0250524 A1
(43) Pub. Date: Aug. 10, 2023

(54) FRICTION STIR PROCESSING FOR CORROSION RESISTANCE

(71) Applicant: Lam Research Corporation, Fremont, CA (US)

(72) Inventors: Keith Joseph Martin, Tualatin, OR (US); Nick Ray Linebarger, JR., Beaverton, OR (US)

(21) Appl. No.: 18/013,742

(22) PCT Filed: Jun. 30, 2021
(86) PCT No.: PCT/US2021/039979

§ 371 Date: Dec. 29, 2022

Related U.S. Application Data
(60) Provisional application No. 62/705,642, filed on Jul. 9, 2020.

(51) Int. Cl. C22F 3/00; C22F 1/04

(52) U.S. Cl. CPC C22F 3/00; C22F 1/04

(57) ABSTRACT

In some examples, techniques for enhancing a corrosion resistance of a component are provided. In some examples, the component includes a granular metallic material. A friction stir processing operation is performed on the material. The friction stir processing operation comprises passing a rotating head of a friction stir welding tool through a surface thickness of the granular metallic material in a treatment path.

### CLAIM OF PRIORITY

This application claims the benefit of priority to U.S. Provisional Pat. Application No. 62/705,642, filed on Jul. 9, 2020, which is incorporated by reference herein in its entirety.

### FIELD

The present disclosure relates generally to techniques for enhancing corrosion resistance of components in a substrate processing chamber, and more particularly to friction stir processing and annealing techniques in that regard.

### BACKGROUND

The raw material of certain components (for example, pedestals and showerheads) in substrate processing chambers includes rolled aluminum plate stock. Typically, this stock has been stress-relieved by the application of one or more stress-relieving techniques, but the resulting microstructure is still left with small elongate grains aligned in the rolling direction. This result runs counter to a desire to produce larger grains on the surfaces of aluminum chamber components in order to reduce corrosion in high temperature, fluorine rich substrate-processing environments. Fluorine can attack the component material at the grain boundaries. By growing the grain size, the density of grain boundaries can be reduced on the surface of the component, thereby reducing corrosion nucleation sites. Unrestrained corrosion can cause the components to eject particles that ultimately end up on the substrate, leading to significant yield losses for wafer producers, for example. Conventional grain-growth techniques, such as the application of high temperature annealing, have been found to be ineffective in this regard.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### BRIEF SUMMARY

In some examples, a method of treating a granular metallic material to affect a grain size of the material is provided. An example method comprises performing a friction stir processing operation on the material, the friction stir processing operation comprising passing a rotating head of a friction stir welding tool through a surface thickness of the granular metallic material in a treatment path.

In some examples, the friction stir processing operation is devoid of a friction stir welding operation.

In some examples, the treatment path includes a treatment pattern, the treatment pattern lying within a surface region of the granular metallic material.

In some examples, a first treatment path in the treatment pattern overlaps with a second treatment path in the treatment pattern.

In some examples, the treatment pattern includes a raster pattern.

In some examples, the treatment pattern includes a spiral pattern.

In some examples, the treatment pattern includes a reciprocating pattern.

In some examples, the treatment pattern includes a serpentine pattern.

In some examples, the surface thickness of the granular metallic material is in the range 1 to 20 millimeters (approximately 0.4 to 7.9 inches)

In some examples, the method of treating the granular metallic material further comprises performing an annealing operation on the granular metallic material.

In some examples, the annealing operation is performed at a temperature in the range of 500 to 600° C.

In some examples, the annealing operation is performed for a duration in the range 0.01 to 24 hours.

In some examples, the granular metallic material includes aluminum.

In some examples, a non-transitory computer-readable storage medium includes instructions that when executed by a computer, cause the computer to implement a friction stir processing operation on a granular metallic material to affect a grain size thereof, the friction stir processing operation comprising passing a rotating head of a friction stir welding tool through a surface thickness of the granular metallic material in a treatment path.

In some examples, the computing apparatus comprises a processor: and a memory storing instructions that, when executed by the processor, configure the apparatus to: implement a friction stir processing operation on a granular metallic material to affect a grain size thereof, the friction stir processing operation comprising passing a rotating head of a friction stir welding tool through a surface thickness of the granular metallic material in a treatment path.

### BRIEF DESCRIPTION OF THE SEVERAL VIEWS OF THE DRAWINGS

Some embodiments are illustrated by way of example and not limitation in the views of the accompanying drawing:

FIG. 1 is a schematic diagram of a processing chamber within which some examples of the present disclosure may be employed, according to some example embodiments.

FIG. 2 illustrates aspects of a friction stir processing operation, in accordance with an example embodiment.

FIGS. 3-6 include cross-sections of a granular metallic material, in accordance with example embodiments.

FIG. 7 illustrates certain operations in a method, in accordance with an example embodiment.

FIG. 8 is a block diagram illustrating an example machine by which one or more example embodiments may be implemented or controlled.

### DETAILED DESCRIPTION

The description that follows includes systems, methods, techniques, instruction sequences, and computing machine program products that embody illustrative embodiments of the present disclosure. In the following description, for purposes of explanation, numerous specific details are set forth in order to provide a thorough understanding of example embodiments. It will be evident, however, to one skilled in the art that the present disclosure may be practiced without these specific details.

A portion of the disclosure of this patent document may contain material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to any data as described below and in the drawings that form a part of this document: Copyright Lam Research Corporation, 2020, All Rights Reserved.

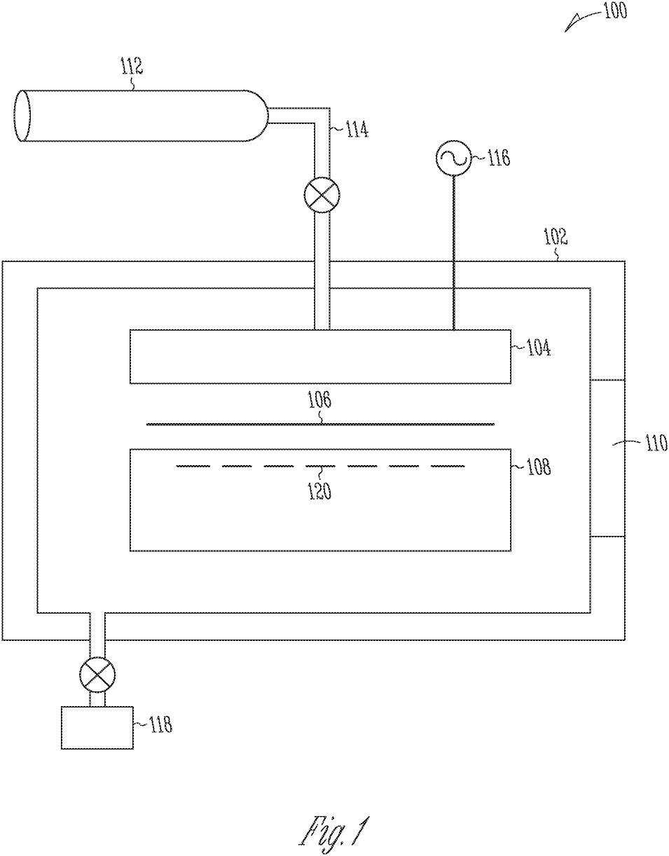

With reference now to FIG. 1, an example arrangement 100 of a plasma-based processing chamber is shown. The present subject matter may be used in a variety of semi-conductor manufacturing and wafer processing operations, but in the illustrated example, the plasma-based processing chamber is described in the context of plasma-enhanced or radical-enhanced Chemical Vapor Deposition (CVD) or Atomic Layer Deposition (ALD) operations. The skilled artisan will recognize that other types of ALD processing techniques are known (e.g., thermal-based ALD operations) and may incorporate a non-plasma-based processing chamber. An ALD tool is a specialized type of CVD processing system in which ALD reactions occur between two or more chemical species. The two or more chemical species are referred to as precursor gases and are used to form a thin film deposition of a material on a substrate, such as a silicon wafer as used in the semiconductor industry. The precursor gases are sequentially introduced into an ALD processing chamber and react with a surface of the substrate to form a deposition layer. Generally, the substrate repeatedly interacts with the precursors to deposit slowly an increasingly thick layer of one or more material films on the substrate. In certain applications, multiple precursor gases may be used to form various types of film or films during a substrate manufacturing process.

FIG. 1 is shown to include a plasma-based processing chamber 102 in which a showerhead 104 (which may be a showerhead electrode) and a substrate-support assembly 108 or pedestal are disposed. Typically, the substrate-support assembly 108 provides a substantially-isothermal surface and may serve as both a heating element and a heat sink for a substrate 106. The substrate-support assembly 108 may comprise an Electrostatic Chuck (ESC) in which heating elements are included to aid in processing the substrate 106, as described above. The substrate 106 may include a wafer comprising, for example, elemental-semiconductor materials (e.g., silicon (Si) or germanium (Ge)) or compound-semiconductor materials (e.g., silicon gennanium (SiGe) or gallium arsenide (GaAs)). Additionally, other substrates include, for example, dielectric materials such as quartz, sapphire, semi-crystalline polymers, or other non-metallic and non-semiconductor materials.

In operation, the substrate 106 is loaded through a loading port 110 onto the substrate-support assembly 108. A gas line 114 can supply one or more process gases (e.g., precursor gases) to the showerhead 104. In turn, the showerhead 104 delivers the one or more process gases into the plasma-based processing chamber 102. A gas source 112 (e.g., one or more precursor gas ampules) to supply the one or more process gases is coupled to the gas line 114. In some examples, an RF (radio frequency) power source 116 is coupled to the showerhead 104. In other examples, a power source is coupled to the substrate-support assembly 108 or ESC.

Prior to entry into the showerhead 104 and downstream of the gas line 114, a point-of-use (POU) and manifold combination (not shown) controls entry of the one or more process gases into the plasma-based processing chamber 102. In the case of a plasma-based processing chamber 102 used to deposit thin films in a plasma-enhanced ALD operation, precursor gases may be mixed in the showerhead 104.

In operation, the plasma-based processing chamber 102 is evacuated by a vacuum pump 118. RF power is capacitively coupled between the showerhead 104 and a lower electrode 120 contained within or on the substrate-support assembly 108. The substrate-support assembly 108 is typically supplied with two or more RF frequencies. For example, in various embodiments, the RF frequencies may be selected from at least one frequency at about 1 MHz, 2 MHz, 13.56 MHz, 27 MHz, 60 MHz, and other frequencies as desired. A coil designed to block or partially block a particular RF frequency can be designed as needed. Therefore, particular frequencies discussed herein are provided merely for ease in understanding. The RF power is used to energize the one or more process gases into a plasma in the space between the substrate 106 and the showerhead 104. The plasma can assist in depositing various layers (not shown) on the substrate 106. In other applications, the plasma can be used to etch device features into the various layers on the substrate 106. RF power is coupled through at least the substrate-support assembly 108. The substrate-support assembly 108 may have heaters (not shown in FIG. 1) incorporated therein. The detailed design of the plasma-based processing chamber 102 may vary.

As mentioned above, the raw material of certain chamber components such as the showerhead 104 and the substrate-support assembly 108 typically includes rolled aluminum plate stock. The rolled stock is often stress relieved, but the resulting microstructure includes small elongate grains aligned in the rolling direction. This small-grained microstructure runs counter to a desire to produce larger grains on the surfaces of aluminum chamber components in order to reduce corrosion, particularly in high temperature, fluorine rich substrate-processing environments within the processing chamber 102. Fluorine can attack the component material at the grain boundaries. By growing the grain size, the density of grain boundaries can be reduced on the surface of the component, thereby reducing corrosion nucleation sites. Unrestrained corrosion can cause the components to eject particles that ultimately end up on the substrate, leading to significant yield losses for wafer producers, for example. Conventional grain-growth techniques, such as the application of high temperature annealing, have been found to be ineffective in this regard.

Some present examples that seek to address these problems employ a friction stir welding (FSW) tool. In some examples, a FSW tool is passed over a surface of a chamber component in a spiral or serpentine raster pattern. Some examples include a degree of overlap between passes. These techniques may be termed “friction stir processing” in some examples, and differ appreciably from the standard use of an FSW tool, namely, to join two components together along a friction stir weld line. Here, no components are, or need be, joined together. Instead, the application of the FSW tool to the surface of a component invokes a thermomechanical process which breaks up the material grains of the component into much smaller grains. In some examples, the grains include equiaxed (spherically shaped) grains. In some examples, application of the FSW tool to the component surface imparts residual stress into the material of the component.

In some examples, a subsequent annealing operation at temperatures in the range of 500 to 600° C. for 1 to 24 hours (for aluminum) is applied to grow the material grains to a much larger size than the original material. In some examples, the friction stir processing includes a solid state process, meaning it does not take the material above its melting point (unlike traditional welding) and therefore does not cause alloying compounds, typically used for strengthening, to diffuse back into the bulk of the material thereby negating their strengthening effects.

In some examples, friction stir processing is applied as a step in a manufacturing process to homogenize a chamber component at an intended grain size. In some examples, the homogenizing step is a final step in the manufacturing process. In some examples, friction stir processing is applied selectively to different regions of the surface of a component. In some friction stir processing examples, appropriate selection of a welding head of an FSW tool, and/or one or more process parameters, enables control of grain size. Some examples enable control of grain size as a function of depth from the free surface of a component. Some examples enable an ability to trade off strength or thermal conductivity against corrosion resistance in various regions of a component or from surface to surface. Some examples enable the provision of a uniform or non-uniform appearance on a component surface as may be desired, for example a component surface closest to a substrate during processing.

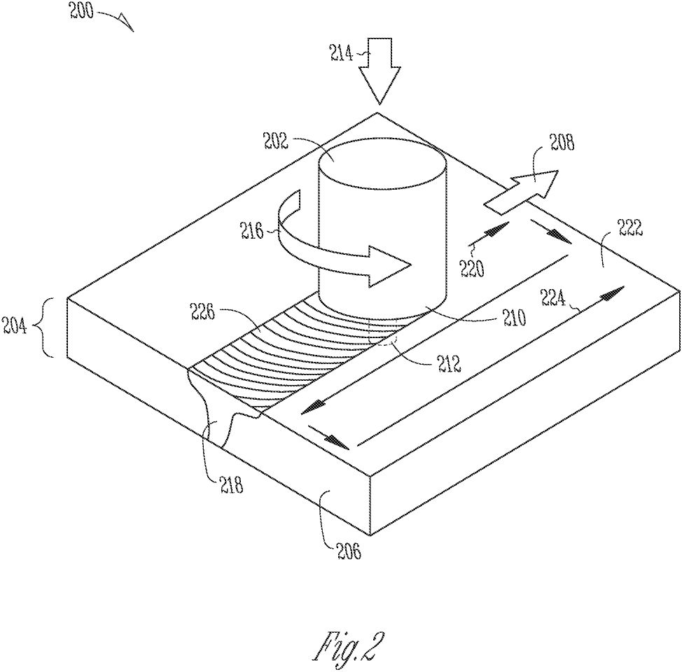

With reference to FIG. 2, aspects of a friction stir processing operation 200 in a method of treating a granular metallic material are illustrated. The friction stir processing operation 200 includes passing a rotating head 202 of a friction stir welding tool through a surface thickness 204 of a granular metallic material 206 in an advancement direction 208 of a treatment path 220. In some examples, the surface thickness 204 of the metallic material 206 is in the range 1 to 20 millimeters (approximately 0.4 to 7.9 inches). A downward force 214 is applied to the FSW tool during the friction stir processing operation 200, and it is caused to rotate in a rotation direction 216.

The metallic material 206 of the present example includes aluminum. Other materials or combinations of material are possible. The metallic material 206 forms part of a component of a processing chamber, such as the processing chamber 102 of FIG. 1. An example component includes a showerhead 104 or a substrate-support assembly 108, or a sub-component of either.

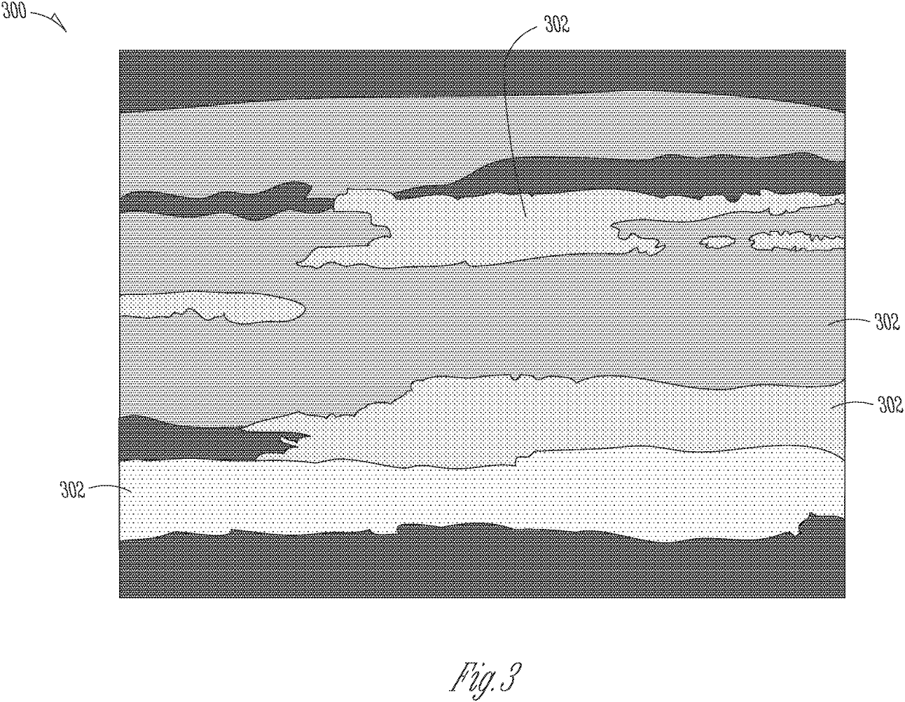

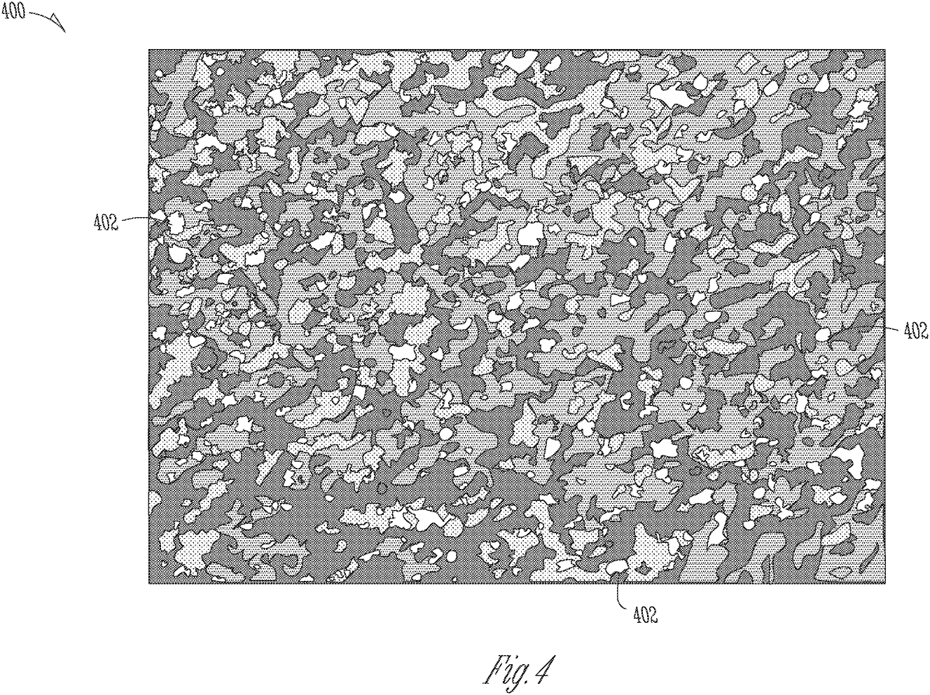

The head 202 of the FSW tool includes a shoulder 210 and a pin 212. Other parts are possible. In the illustrated example, the pin 212 of the FSW tool engages with the metallic material 206. The engagement of the rotating pin 212 (as part of the head 202) with the metallic material 206 invokes a thermomechanical process which breaks up the material grains of the metallic material 206. Example aligned grains of an original, rolled metallic material 206 may be seen in FIG. 3. Example grains resulting from an application of the friction stir processing operation 200, at a treated surface 226 of the metallic material 206, may be seen in FIG. 4. It will be seen that the grain size of the metallic material 206 has been affected by the friction stir processing operation 200. In this example, the grains have been reduced in size and are unaligned. Other effects of a friction stir processing operation 200 are possible. The affected grains lie in an affected zone 218 ( or nugget) behind the advancing head 202 of the FSW tool.

During the friction stir processing operation 200, the advancing, rotating head 202 of the FSW tool travels in a treatment path 220. The treatment path 220 may be linear or curved, or include a single line. In some examples, the treatment path 220 includes a treatment pattern 224. An example treatment pattern 224 lies within an example surface region 222 of the granular metallic material 206, as shown.

In some examples, the surface region 222 is devoid of welds, and the friction stir processing operation 200 is devoid of other FSW operations. In other words, the FSW processing operation 200 is not preceded or succeeded (directly or indirectly) by a conventional FSW operation. In some examples the surface region 222 forms part of a single or monolithic component or a homogenous metallic material 206 without the presence of joint lines or assembly features in the surface region 222.

In some examples, the treatment pattern 224 includes a raster pattern, substantially as illustrated for example. In some examples, the treatment pattern 224 includes a spiral, reciprocating or serpentine pattern, or a combinations of two or more of these patterns. The treatment pattern 224 may traverse a full or limited extent of the surface region 222. In some examples, a first treatment path in a treatment pattern overlaps with a second treatment path in the treatment pattern. A degree of overlap of the second treatment path with respect to the first treatment path may be in the range 0.5 to 99 percent, with some examples in the range 1 to 10 percent.

In some examples, the method of treating a granular metallic material includes an annealing operation on the granular metallic material. In some examples, the annealing operation is performed after the friction stir processing operation 200. In some examples, the annealing operation is performed at a temperature in the range of 500 to 600° C. In some examples, annealing operation is performed for a duration in the range 1 to 24 hours.

With reference to FIG. 3, this view includes a cross-section 300 of a typical rolled metallic material 206, such as aluminum plate stock in this case. Typically, this stock has been stress-relieved by the application of one or more stress-relieving or annealing techniques, but the resulting microstructure is left with small elongate grains 302 aligned in a rolling direction, as shown. As discussed above, this alignment and/or smaller-sized grains runs counter to a desire to produce larger grains on the surfaces of aluminum chamber components in order to reduce corrosion in high temperature, fluorine rich substrate-processing environments, for example. Fluorine can attack the component material at the grain boundaries.

With reference to FIG. 4, this view includes a corresponding cross-section 400 of the same metallic material 206 as in FIG. 3, but taken after a friction stir processing operation 200 and before annealing. The friction stir processing operation 200 has affected the size of the grains 402 and caused, in this example, a relative grain size reduction, as shown.

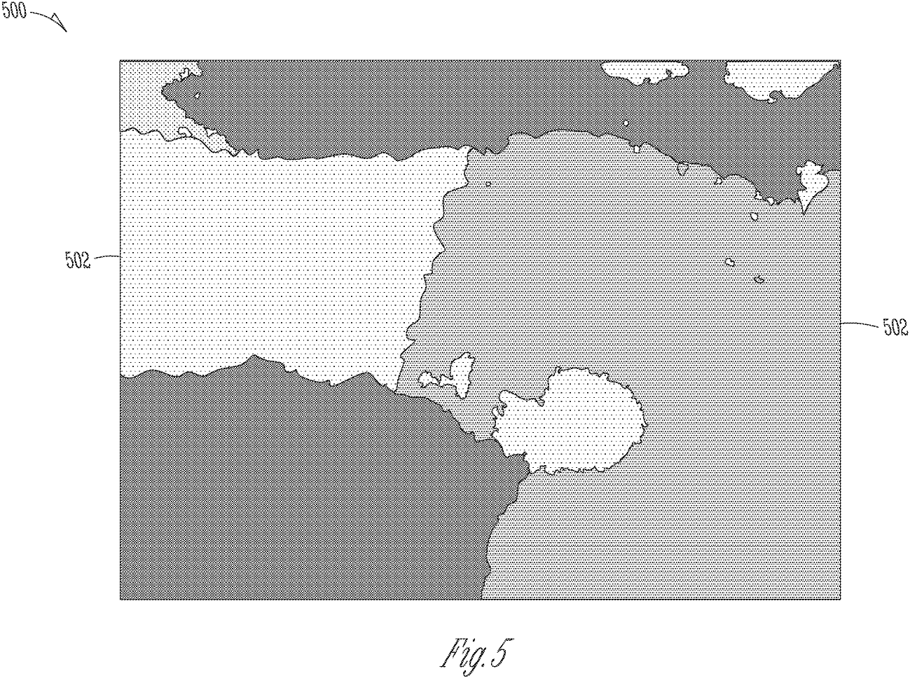

With reference to FIG. 5, this view includes a corresponding cross-section 500 of the same metallic material 206 as in FIG. 3 and FIG. 4, but taken after an annealing operation has been performed on the metallic material 206. In some examples, the annealing operation is performed after the friction stir processing operation 200. In some examples, the annealing operation is performed at a temperature in the range of 500 to 600° C. In some examples, annealing operation is performed for a duration in the range 1 to 24 hours. The annealing operation affects the size of the grains 502 and has caused, in this example, a relative and significant grain size increase, as shown.

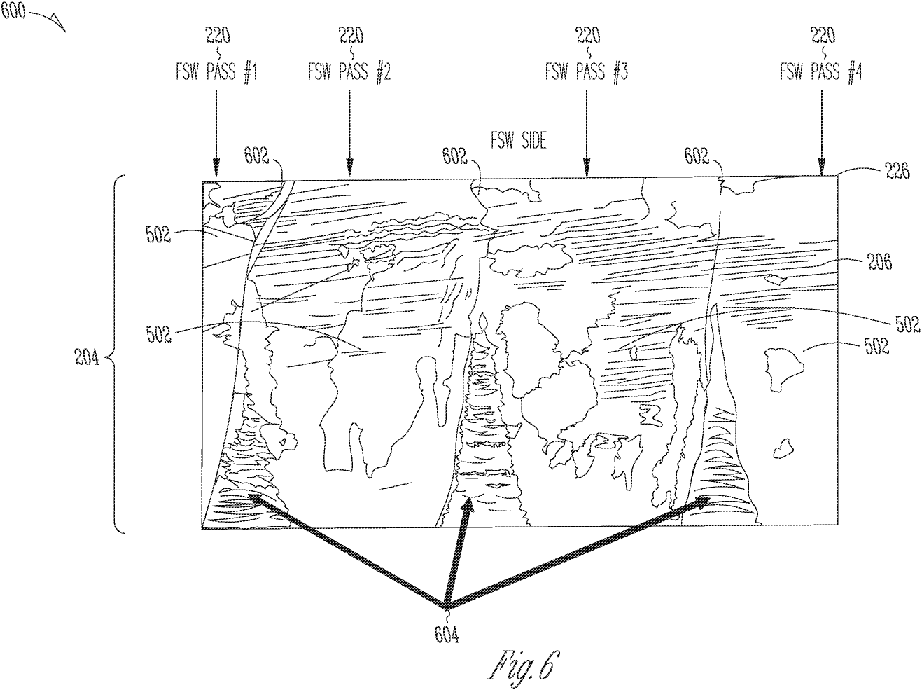

FIG. 6 includes an enlarged cross-section 600 of a surface thickness 204 of a metallic material 206 that has been fully treated by a friction stir processing operation 200 followed by an annealing operation at 525C for 16 hours in air. Large grains 502 have been formed by the friction stir processing operation 200 and may be observed in respective treatment path 220 of the head 202 of the FSW tool. In this example, a treatment pattern 224 that includes a raster pattern has been used, such that two of the treatment path 220 (for example, the first and third) proceed away from the reader (into the page) and two of the treatment path 220 (for example second and fourth) proceed towards the reader (out of the page). In this example, the treatment path 220 overlap at the treated surface 226 of the metallic material 206. By growing the size of the grains 502 by virtue of the friction stir processing operation 200 and subsequent annealing operation, the density of grain boundaries 602 on the treated surface 226 the component has been reduced, thereby reducing corrosion nucleation sites on the component during substrate processing. The untreated regions 604 showing the retained microstructure of the original rolled plate stock of FIG. 3. An increased overlap of treatment path 220 in a treatment pattern 224 would convert these untreated regions 604 into large grain regions.

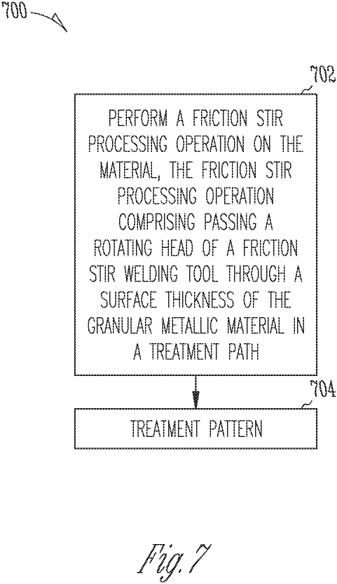

Some embodiments herein include methods. With reference to FIG. 7, in operation 702, a method of treating a granular metallic material 700 includes performing a friction stir processing operation on the metallic material. The friction stir processing operation comprises passing a rotating head of a friction stir welding tool through a surface thickness of the granular metallic material in a treatment path. In operation 704, the method of treating a granular metallic material 700 includes utilizing a treatment pattern that includes one or more treatment paths. The method 700 may include further operations as summarized above, or described elsewhere herein.

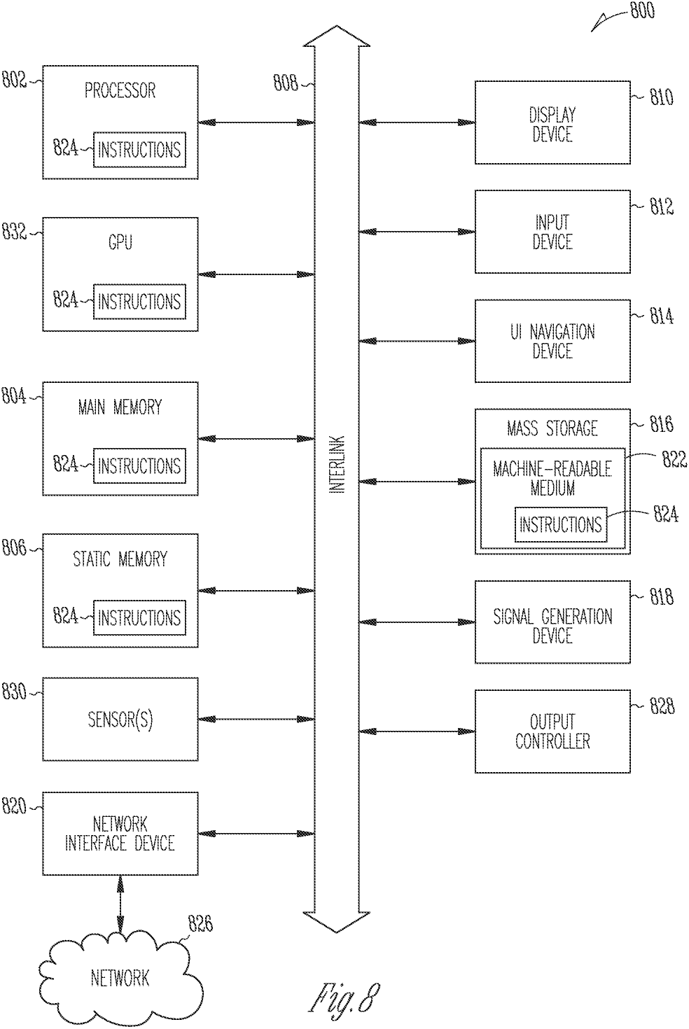

FIG. 8 is a block diagram illustrating an example of a machine or controller 800 by which one or more example embodiments described herein may be implemented or controlled. In alternative embodiments, the controller 800 may operate as a standalone device or may be connected (e.g., networked) to other machines. In a networked deployment, the controller 800 may operate in the capacity of a server machine, a client machine, or both in server-client network environments. In an example, the controller 800 may act as a peer machine in a peer-to-peer (P2P) (or other distributed) network environment. Further, while only a single controller 800 is illustrated, the term “machine” (controller) shall also be taken to include any collection of machines (controllers) that individually or jointly execute a set (or multiple sets) of instructions to perform any one or more of the methodologies discussed herein, such as via cloud computing, software as a service (SaaS), or other computer cluster configurations. In some examples, and referring to FIG. 8, a non-transitory machine-readable medium includes Instructions 824 that, when read by a controller 800, cause the controller to control operations in methods comprising at least the non-limiting example operations described herein.

Examples, as described herein, may include, or may operate by logic, a number of components, or mechanisms. Circuitry is a collection of circuits implemented in tangible entities that include hardware (e.g., simple circuits, gates, logic, etc.). Circuitry membership may be flexible over time and underlying hardware variability. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a Computer-Readable Medium physically modified (e.g., magnetically, electrically, by moveable placement of invariant massed particles, etc.) to encode instructions of the specific operation. In connecting the physical components, the underlying electrical properties of a hardware constituent are changed (for example, from an insulator to a conductor or vice versa). The instructions enable embedded hardware (e.g., the execution units or a loading mechanism) to create members of the circuitry in hardware via the variable connections to carry out portions of the specific operation when in operation. Accordingly, the Computer-Readable Medium is communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry, at a different time.

The machine (e.g., computer system) controller 800 may include a hardware Processor 802 (e.g., a central processing unit (CPU), a hardware processor core, or any combination thereof), a GPU 832 (graphics processing unit), a main memory 804, and a static memory 806, some or all of which may communicate with each other via an interlink 808 (e.g., a bus) The controller 800 may further include a display device 810, an alphanumeric input device 812 (e.g., a keyboard), and a UI navigation device 814 (e.g., a mouse or other user interface). In an example, the display device 810, alphanumeric input device 812, and UI navigation device 814 may be a touch screen display. The controller 800 may additionally include a mass storage device 816 (e.g., drive unit), a signal generation device 818 (e.g., a speaker), a network interface device 820, and one or more sensors 830, such as a Global Positioning System (GPS) sensor, compass, accelerometer, or another sensor. The controller 800 may include an output controller 828, such as a serial (e.g., universal serial bus (USB)), parallel, or other wired or wireless (e.g., infrared (IR), near field communication (NFC), etc.) connection to communicate with or control one or more peripheral devices (e.g., a printer, card reader, etc.).

The mass storage device 816 may include a machine-readable medium 822 on which is stored one or more sets of data structures or instructions 824 (e.g., software) embodying or utilized by any one or more of the techniques or functions described herein. The instructions 824 may as shown also reside, completely or at least partially, within the main memory 804, within the static memory 806, within the hardware processor 802, or within the GPU 832 during execution thereof by the controller 800. In an example, one or any combination of the hardware processor 802, the GPU 832, the main memory 804, the static memory 806. or the mass storage device 816 may constitute the machine-readable medium 822.

While the machine-readable medium 822 is illustrated as a single medium, the term “machine-readable medium” may include a single medium, or multiple media (e.g., a centralized or distributed database, and/or associated caches and servers) configured to store the one or more instructions 824.

The term “machine-readable medium” may include any medium that can store, encode, or carry instructions 824 for execution by the controller 800 and that cause the controller 800 to perform any one or more of the techniques of the present disclosure, or that can store, encode, or carry data structures used by or associated with such instructions 824. Non-limiting machine-readable medium examples may include solid-state memories, and optical and magnetic media. In an example, a massed machine-readable medium comprises a machine-readable medium 822 with a plurality of particles having invariant (e.g., rest) mass. Accordingly, massed machine-readable media are not transitory propagating signals. Specific examples of massed machine-readable media may include non-volatile memory, such as semiconductor memory devices (e.g., electrically programmable read-only memory (EPROM), electrically erasable programmable read-only memory (EEPROM)) and flash memory devices; magnetic disks, such as internal hard disks and removable disks; magneto-optical disks; and CD-ROM and DVD-ROM disks. The instructions 824 may further be transmitted or received over a communications network 826 using a transmission medium via the network interface device 820.

Although examples have been described with reference to specific example embodiments or methods, it will be evident that various modifications and changes may be made to these embodiments without departing from the broader scope of the embodiments. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This detailed description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A method of treating a granular metallic material to affect a grain size of the material, the method comprising:
performing a friction stir processing operation on the material, the friction stir processing operation comprising passing a rotating head of a friction stir welding tool through a surface thickness of the granular metallic material in a treatment path.

2. The method of claim 1, wherein the friction stir processing operation is devoid of a friction stir welding operation.

3. The method of claim 1, wherein the treatment path includes a treatment pattern, the treatment pattern lying within a surface region of the granular metallic material.

4. The method of claim 3, wherein a first treatment path in the treatment pattern overlaps with a second treatment path in the treatment pattern.

5. The method of claim 3, wherein in the treatment pattern includes a raster pattern.

6. The method of claim 3, wherein the treatment pattern includes a spiral pattern.

7. The method of claim 3, wherein the treatment pattern includes a reciprocating pattern.

8. The method of claim 3, wherein the treatment pattern includes a serpentine pattern.

9. The method of claim 1, wherein the surface thickness of the granular metallic material is in the range 1 to 20 millimeters (approximately 0.4 to 7.9 inches).

10. The method of claim 1, wherein the method of treating the granular metallic material further comprises performing an annealing operation on the granular metallic material.

11. The method of claim 10, wherein the annealing operation is performed at a temperature in the range of 500 to 600° C.

12. The method of claim 10, wherein the annealing operation is performed for a duration in the range 0.01 to 24 hours.

13. The method of claim 1, wherein the granular metallic material includes aluminum.

14. A computer-readable storage medium, the computer-readable storage medium including instructions that when executed by a computer, cause the computer to perform operations comprising, at least:
implement a friction stir processing operation on a granular metallic material to affect a grain size thereof, the friction stir processing operation comprising passing a rotating head of a friction stir welding tool through a surface thickness of the granular metallic material in a treatment path.

15. A computing apparatus, the computing apparatus comprising:
a processor; and
a memory storing instructions that, when executed by the processor, configure the computing apparatus to perform operations comprising, at least:
implement a friction stir processing operation on a granular metallic material to affect a grain size thereof, the friction stir processing operation comprising passing a rotating head of a friction stir welding tool through a surface thickness of the granular metallic material in a treatment path.
